(19) United States
(12) Patent Application Publication
(10) Pub. No.: US 2003/0126130 A1
(43) Pub. Date: Jul. 3, 2003

(54) Sort slider with context intuitive sort keys

(75) Inventors: Jacquelyn Martino, Cold Springs, NY (US); John Zimmerman, Ossining, NY (US); Henk Lamers, Maarheeze (NL); Guy Roberts, Eindhoven (NL); Jeanne de Bont, Maarheeze (NL)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V., Eindhoven (NL)

(21) Appl. No.: 10/037,445

(22) Filed: Dec. 31, 2001

(51) Int. Cl. G06F 17/30

(52) U.S. Cl. 707/7

(57) ABSTRACT

A sorting mechanism sorts results utilizing one or more sort keys selected based upon the user task context, the content type relating to the items being sorted, and/or user-preferences. Intuitive or default sort keys such as program/song title are selected based on the user's objectives as inferred from task parameters or user selection of primary sort keys, but may be changed by the user, with the results are displayed in an ordered listing based on the sorting with the selected sort keys.

### CROSS-REFERENCE TO RELATED APPLICATIONS

The present invention is related to those disclosed in the following United States Non-Provisional Patent Applications:

1) No. ______ [Docket No. US010683] filed concurrently herewith, entitled “METHOD OF POPULATING AN EXPLICIT PROFILE”;

2) No. ______ [Docket No. US010684] filed concurrently herewith, entitled “METHOD AND APPARATUS FOR ACCESS AND DISPLAY OF CONTENT ALLOWING USERS TO APPLY MULTIPLE PROFILES”;

3) No. ______ [Docket No. US010686] filed concurrently herewith, entitled “VISUALIZATION OF ENTERTAINMENT CONTENT.”

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed, in general, to search systems and, more specifically, to search systems producing ordered lists of results.

### BACKGROUND OF THE INVENTION

Various search tools produce ordered lists of results sorted based on attributes of the listed items. For example, within entertainment systems users can often sort lists of content by title, genre, time of day, channel, actors, directors, or even by recommendation or rating when a recommender is employed as part of the search system. However, default sort keys employed by a system are often unsatisfactory to the user.

There is, therefore, a need in the art for a sort tool employing context-dependent primary and secondary sort keys applied among and across content types.

### SUMMARY OF THE INVENTION

To address the above-discussed deficiencies of the prior art, it is a primary object of the present invention to provide, for use in content reception system, a sorting mechanism utilizing content type and/or user task context to automatically determine the a primary sort key and any additional (e.g., secondary) sort keys. Intuitive or default sort keys such as program/song title may be changed by the user, with the system learning which combinations of sort keys are preferred by the user. The results are displayed in an ordered listing based on the sorting with the primary and additional sort keys (if any), and with a slider user control calibrated to the number of primary sort groupings rather than the total number of items sorted.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts content reception system employing a sort mechanism utilizing adaptable primary and secondary sort keys depending on content type according to one embodiment of the present invention;

FIGS. 2A through 2C are mockups of a user interface display for content reception system controller employing a sort mechanism utilizing adaptable sort keys depending on user task context and/or content type according to one embodiment of the present invention; and

FIG. 3 is a high level flowchart for a sort process utilizing adaptable sort keys depending on user task context and/or content type according to one embodiment of the present invention.

### DETAILED DESCRIPTION OF THE INVENTION

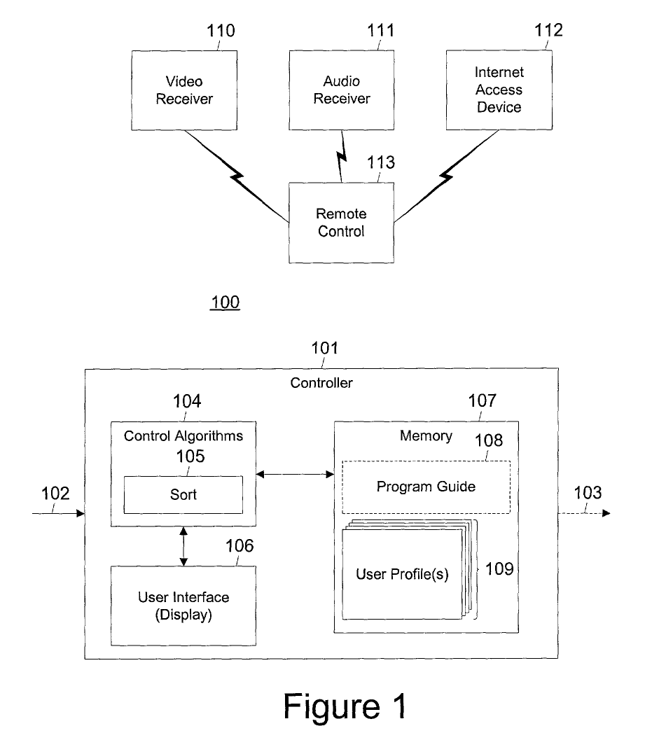

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts content reception system employing a sort mechanism utilizing adaptable primary and secondary sort keys depending on content type according to one embodiment of the present invention. Within a content reception system 100, a controller 101 receives at least information regarding content available from one or more external sources (not shown) such as a broadcasting facility or a broadcast or Internet content server, as well as optionally the associated content. Accordingly, controller 101 may be implemented within a video receiver 110 such as a television, a satellite, terrestrial, or cable broadcast decoder unit, a digital video recorder, within an audio receiver 111 such as a terrestrial or satellite radio receiver or a compact disc or digital audio player, or within an Internet access device 112 such as a set-top box, a personal computer or the like. Additionally, controller 101 may be implemented within a remote control device 113 adapted for controlling the operation of one or more of the video receiver 110, the audio receiver 111, and the Internet access device 112, and optionally including an integral display and the like. Controller 101 may also be implemented in a distributed fashion, with various portions being disposed within two or more devices forming the video receiver 110, the audio receiver 111, the Internet access device 112, and the remote control 113.

However implemented, content reception system controller 101 includes an input 102 for receiving at least the information regarding content available from the external sources and optionally an output 103 for transmitting content, control signals, and/or user interface data to a receiver, display or recording device. Moreover, content reception system 100 receives content of different types such as video content formatted as Motion Picture Expert Group level 2 (MPEG-2) digital video signals and audio content formatted as MPEG audio layer 3 (MP3) digital audio signals.

Those skilled in the art will recognize that the full construction and operation of content reception system controller is not depicted or described herein. Instead, for simplicity and clarity, only so much of the construction and operation of a content reception system controller as is unique to the present invention or necessary for and understanding of the present invention is depicted and described. The remainder of the construction and operation of the controller may follow conventional practices known in the art. Moreover, although a video receiver, an audio receiver, an Internet access device, and a remote control are employed in the exemplary embodiment, those skilled in the art will recognize that the functionality described herein may be readily adapted to other types of devices such as, for example, game devices, and thereby employed with other forms of content.

In the exemplary embodiment, controller 101 includes a control algorithms or programmable logic circuits 104 including a sort module or functionality 105. A user interface 106 communicably coupled to the controller 104 enables user input from, for example, an infrared remote control, a touch screen, or input buttons. User interface 106 may include a display and/or speakers or, alternatively, content reception system 100 may be coupled to a separate display device and/or sound system. Controller 101 in the exemplary embodiment also includes a memory 107, preferably nonvolatile. Memory 107 is employed to optionally store received information 108 about available content (e.g., a program guide) and to store one or more user profiles 109.

User profiles 109 in the example shown are explicit profiles of user preferences for use by an optional recommender module and having, associated with each item or attribute, an item type and a user rating value for the respective item, although other types of profiles such as collected historical viewing information may be employed. The recommender functionality may be coupled to the sort mechanism for use of attributes such as relevance, rating or recommendation value during sorting. Sort controller 105, the optional recommender, and user profiles 109 may, of course, be located on a remote system from controller 101 and transmit sorted data to controller 101.

In the exemplary embodiment of the present invention, based on contextual awareness of the user task being performed and meta-data regarding content type and user preferences, sort controller 105 (or a sort controller located elsewhere and communicably coupled to controller 101) selects primary and secondary sort keys for sorting content listings as described in further detail below. Moreover, those skilled in the art will recognize that while the exemplary embodiment relates to an entertainment system, the present invention may be employed with any data processing system employing a sorting mechanism.

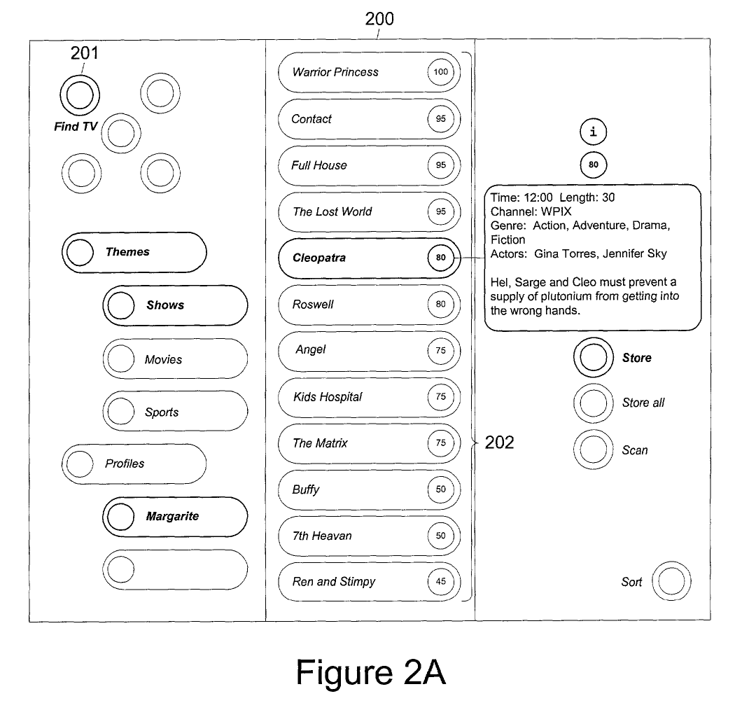

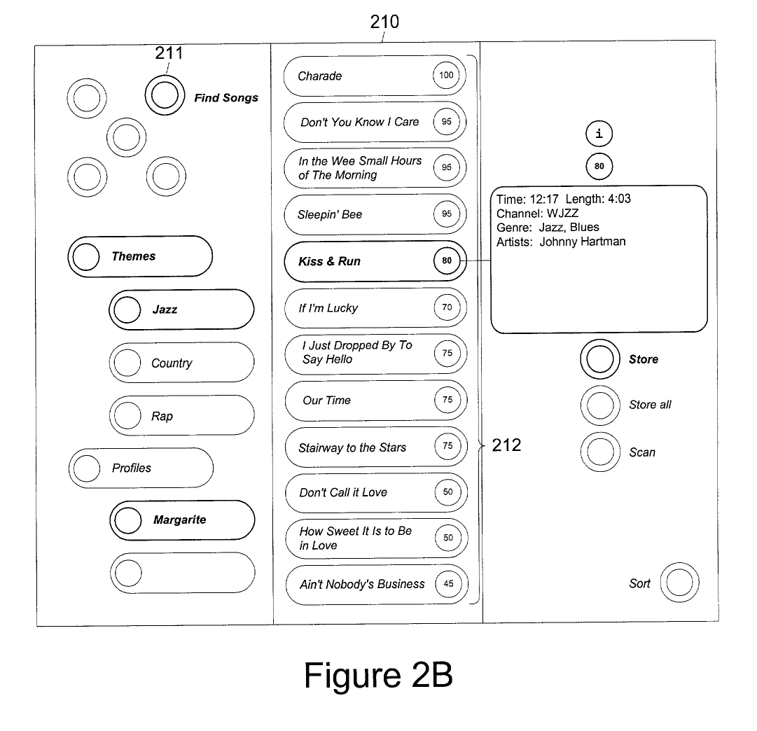

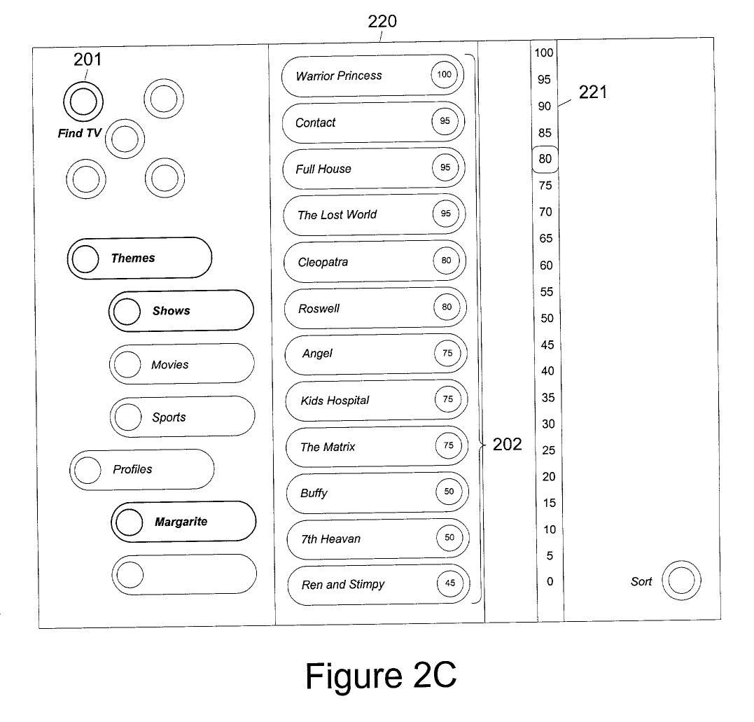

FIGS. 2A through 2C are mockups of a user interface display for content reception system controller employing a sort mechanism utilizing adaptable sort keys depending on user task context and/or content type according to one embodiment of the present invention. The user interfaces depicted are employed, for example, by controller 101 depicted in FIG. 1. User interface display 200 in FIG. 2A includes a user control 201 for searching for content based on content information (the program guide). Searches may be performed for different purposes or in different manners. For example, user searches may be performed either to record, to playback from previous recording, or to contemporaneously view, or with a desire find a specific item rather than to browse available content. Depending on the task which the user is attempting to complete, the system may utilize the user task context to automatically select primary, secondary, and other (e.g., tertiary) sort keys for ordering the results list.

For instance, if the user is searching for recommendations of content to record based on a user profile, the system may automatically sort results based on recommendation rating (primary sort key) and, for content items having the same rating value, alphabetically by title (secondary sort key), the ordering which would most effectively help the user complete the task of selecting content to record.

On the other hand, if the user is simply searching for currently available content to contemporaneously view without regard to relevance to the user's profile, the system may automatically select program time as the primary sort key and channel as the secondary sort key to present the search results in the most useful fashion to the user. Similarly, if the user is searching previously recorded content for playback, the system may automatically select rating or, if recorded content “ages” and becomes subject to being overwritten, recording time as the primary sort key.

The system also allows the user to select alternate sort keys, and may infer a user task context from such changes. For example, in searching for content to record based on a profile of preferences as described above, the user may selectively change the primary sort key to, e.g., program title, actor, or director. When the user alters the primary sort key in that manner, the system recognizes that the user is no longer simply browsing for content, but is now searching for a specific item. The system therefore automatically adapts the secondary and remaining sort keys as a result of the context change, setting the secondary sort key to, e.g., program time. Intuitive and natural secondary and lower-order sort keys are selected based on context, content type, and user preferences explicitly or implicitly inferred from the user profile from metadata labels within the received content information such as, for instance, field names of a database. Heuristics or rules may be defined for selecting the primary, secondary and/or lower-order sort keys, or default sort keys may be simply set and/or modified by the user. In the example of searching for content matching a profile of user preferences, program title is intuitively the best secondary sort key, although broadcaster or other attributes from the metadata may be selected.

It should be noted that the secondary sort key need not coincide with the attribute(s) displayed within listing 202. Instead, one attribute (e.g., broadcaster) may be employed as the secondary sort key while a second attribute (e.g., program title) may be displayed within listing 202.

Users may also specify secondary or lower-order sort keys. The attributes which may be selected as a sort key include the entire array of attributes available for selection as the primary sort key minus the one attribute selected as the primary sort key. For example, if the attributes which might be selected as the primary sort key include rating, title, time and channel, and rating is selection as the primary sort key, the attributes available for selection as the secondary sort key are limited to title, time and channel. The constraint continues to lower-order (e.g., tertiary) sort keys, where the available field excludes the attributes selected for higher order sort keys.

The system also observes how different users prefer to sort results of specific tasks to learn which criteria are preferred (and stores such preferences within the user profile). The system can then automatically select appropriate sort keys for each task depending on the particular user currently employing the system. The learning capability of the system extends to sort key combinations (primary and secondary) as well as to single sort key preferences.

In the present invention, the sort keys are also dependent on the content type being searched, with different sort key combinations being set by default for the system, or derived from user histories, for specific content types. User interface display 210 in FIG. 2B includes a user control 211 for searching for currently available audio content based on ratings within the selected user profile for various audio (e.g., music) attributes and the received content information. The secondary sort key employed in sorting listing 212 may differ substantially than the secondary sort key employed in sorting listing 202. While the program (song) title remains an intuitive secondary sort key, the user may optionally specify a different secondary sort key for audio programming (e.g., artist) than for video programming. Thus, in sorting results for display, the controller 105 must first determine the type of content searched, then determine the secondary sort key which should be employed. The system may anticipate sort orders preferred by most people for different content types (e.g., video, songs, books, etc.) in default sort keys or sort key combinations, of, in the learning process, create separate rules within a user profile for each content type and user task context.

Thus, in the present invention, the selection of sort keys is automatic but may be overridden by the user. The most appropriate sort keys are selected based upon the user task context, user, and content type, although the user may specify a different sort key or sort key combination than the default. The system automatically selects (at least primary and secondary) sort keys based on user task context, but infers a context change from user selection of a different primary sort key and then automatically determines secondary or additional sort keys for the new context. Additionally, the system can profile a particular user, such that (repeated) selection of one sort key or sort key combination for a particular task and content type by a user will result in that sort key or sort key combination being set as the default for the corresponding task and content type for that user.

FIG. 2C depicts a user interface 220 including a “slider” user control 221 enabling a user to navigate the sorted listing 202. Slider 221 is graphically depicted by a movable element which may be selectively positioned within an elongated region, and functions as an appropriate scrolling tool based on the primary sort key. Traditional scrolling tools allow users to move proportionally through lists of items based on the total number of items. Rather than calibrating the movable element and elongated region to the total number of items, however, slider 221 is calibrated to the primary sort key groups—that is, each grouping of items having the same value under the primary sort key is treated as a single gradation, offering a non-proportional way of scrolling to specific markers within the list.

For example, if the user sorts a program listing by recommendation, the slider 221 might offer a list sorted by recommendation rating from 100 to 0 grouped in increments of five. Navigating to a marker would move the user to the portion or grouping of the results list containing items matching the primary sort key marker in the slider 221 (e.g., the group of items having a rating value not greater than 80), even though the groupings may be of substantially different sizes. For example, an alphabetic sort is likely to have many more items within the grouping for the letter “s” than for the letters “q” or “x”. By calibrating to primary sort key grouping rather than individual items, however, the present invention allows users to more quickly traverse the sorted listing 202 to a specific grouping.

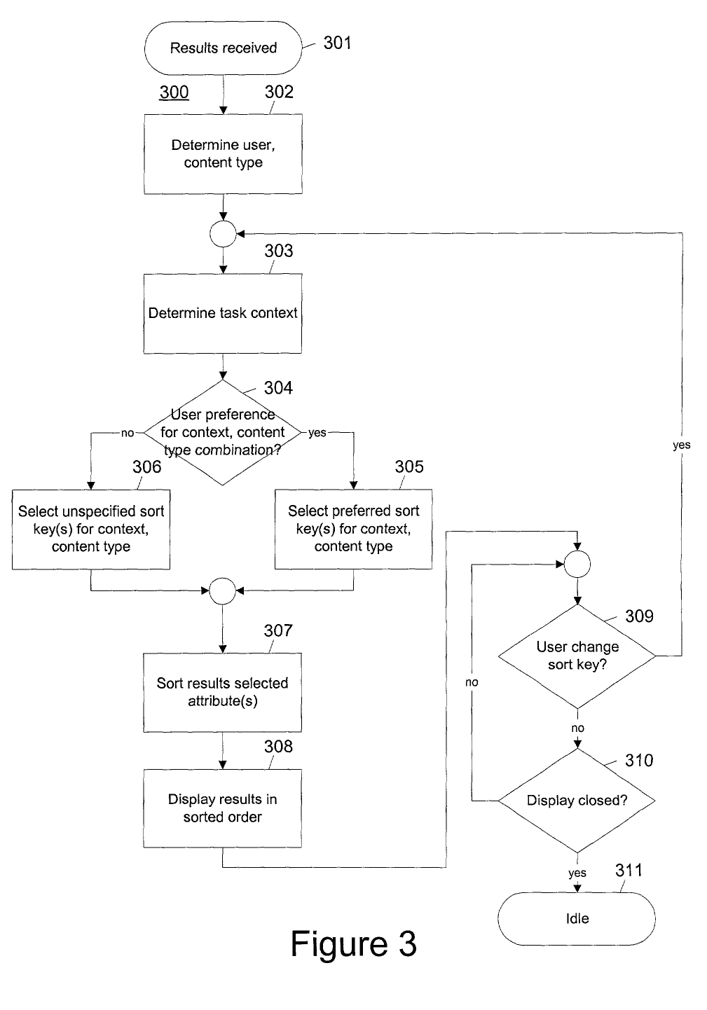

FIG. 3 is a high level flowchart for a sort process utilizing adaptable sort keys depending on user task context and content type according to one embodiment of the present invention. The process 300 begins with results from a search for content being received (step 301). The user and type of content (e.g., audio or video) are first determined (step 302), and then the user task context (search for content to record, browsing currently available content for contemporaneous viewing and/or listening, search previously recorded content for particular item, etc.) is determined (step 303).

A determination is then made of whether user preferences for the context and content type combination have been previously detected (step 304). If so, the user's preference in sort key(s) from a user profile is employed (step 305); otherwise any unspecified sort keys are selected based on appropriateness for the task context and content type (step 306), which may be a default or otherwise globally-specified attribute or attribute combination.

The results are then sorted utilizing the selected sort keys (step 307) and are displayed in sorted order (step 308). If the user changes a sort key (step 309), a context change is inferred and the appropriate sort key(s) for the new task context and content type combination are determined. Most often the primary sort key will be the key changed by the user, and previously defined rules may be applied to determine appropriate sort key(s) for a new task context (e.g., changes to sort keys such as title or other individual names implies a search for a particular item). The process continues until the search results display is closed (step 310), at which time the process becomes idle (step 311) until another set of search results requiring sorting are received.

The present invention allows sorting of results to be varied dependent on the user task context, and the content type and/or user-preferences. The same sorting mechanism may therefore be employed for a variety of content types such as audio, video, games, etc. Moreover, while the exemplary embodiment of the present invention relates to entertainment content, the techniques of the present invention may be readily adapted to sort controllers for other types of goods such as books, consumer electronics, and the like. Accordingly, the term “content” as used herein should be interpreted as relating to any item, or the description of any item, which may be the subject of a search or suggestion.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A sort system comprising:
a sort controller receiving a plurality of information items regarding content,
wherein the sort controller sorts the information items using a current user task context and a content type for the information items to select one or more sort keys for sorting the information items.

2. The sort system according to claim 1, wherein the selected sort keys are derived from user sorting preferences for the current user task context and the content type.

3. The sort system according to claim 1, wherein the selected sort keys include a primary sort key selected by the user and a secondary sort key selected based on a nature of the current user task context inferred from the primary sort key selected by the user.

4. The sort system according to claim 1, wherein a change in the current user task context is inferred from a change of the primary sort key by the user.

5. The sort system according to claim 1, wherein the plurality of information items are displayed in an order determined by the sort controller together with a user control calibrated to groupings having equivalent values under the primary sort key.

6. An audio/video receiver comprising:
an input for receiving content and a plurality of information items regarding the content; and
a sort controller receiving and sorting the information items using a current user task context and a content type for the information items to select one or more sort keys for sorting the information items.

7. The audio/video receiver according to claim 6, wherein the selected sort keys are derived from user sorting preferences for the current user task context and the content type.

8. The audio/video receiver according to claim 6, wherein the selected sort keys include a primary sort key selected by the user and a secondary sort key selected based on a nature of the current user task context inferred from the primary sort key selected by the user.

9. The audio/video receiver according to claim 6, wherein a change in the current user task context is inferred from a change of the primary sort key by the user.

10. The audio/video receiver according to claim 6, wherein the plurality of information items are displayed in an order determined by the sort controller together with a user control calibrated to groupings having equivalent values under the primary sort key.

11. A sorting method comprising:
receiving content and a plurality of information items regarding the content; and
sorting the information items using a current user task context and a content type for the information items to select one or more sort keys for sorting the information items.

12. The method according to claim 11, wherein the selected sort keys are derived from user sorting preferences for the current user task context and the content type.

13. The method according to claim 11, wherein the selected sort keys include a primary sort key selected by the user and a secondary sort key selected based on a nature of the current user task context inferred from the primary sort key selected by the user.

14. The method according to claim 11, wherein a change in the current user task context is inferred from a change of the primary sort key by the user.

15. The method according to claim 11, further comprising:
displaying the plurality of information items are displayed in an order determined by sorting using the primary and secondary sort keys together with a user control calibrated to groupings having equivalent values under the primary sort key.

16. A signal comprising:
an ordered listing of information items,
wherein the ordered listing is derived by sorting a plurality of information items using a current user task context and a content type for the information items to select one or more sort keys for sorting the information items.

17. The signal according to claim 16, wherein the selected sort keys are derived from user sorting preferences for the current user task context and the content type.

18. The signal according to claim 16, wherein the selected sort keys include a primary sort key selected by the user and a secondary sort key selected based on a nature of the current user task context inferred from the primary sort key selected by the user.

19. The signal according to claim 16, wherein a change in the current user task context is inferred from a change of the primary sort key by the user.

20. The signal according to claim 16, wherein the ordered listing is adapted for generating a display of the ordered listing of information items in an order determined by sorting using the primary and secondary sort keys together with a user control calibrated to groupings having equivalent values under the primary sort key.
